(19) United States
(12) Patent Application Publication
(10) Pub. No.: US 2021/0312476 A1
(43) Pub. Date: Oct. 7, 2021

(54) INFORMATION PROCESSING DEVICE, INFORMATION PROCESSING METHOD, AND PROGRAM

(71) Applicant: SONY CORPORATION, TOKYO (JP)

(72) Inventors: MASATO KITA, TOKYO (US); KAZUYUKI SAKAMOTO, TOKYO (JP); HIROYUKI KAMATA, TOKYO (JP)

(21) Appl. No.: 17/250,618

(22) PCT Filed: Aug. 2, 2019
(86) PCT No.: PCT/JP2019/030601

§ 371 Date: Feb. 11, 2021

(30) Foreign Application Priority Data
Aug. 23, 2018 (JP) 2018-156600

(51) Int. Cl. G06Q 30/02; H04W 4/33; H04W 4/38; H04W 4/029; G06K 9/00; G06Q 20/32

(52) U.S. Cl. CPC G06Q 30/0201; H04W 4/33; H04W 4/38; G06Q 20/322; G06Q 30/0207; G06K 9/00778; H04W 4/029

(57) ABSTRACT

Provided is an information processing device (10) including a path computation unit (134) that computes, starting from a payment position where a user (U) entering a store (40) pays, a movement path of the user in the store retrospectively according to time-series sensing data about the user obtained before the payment.

### TECHNICAL FIELD

The present disclosure relates to an information processing device, an information processing method, and a program.

### BACKGROUND ART

A technology for acquiring the movement path (movement line) of a customer in a store has become prevalent. Using the acquired movement path of the customer, the store can know the purchase tendency or behavior pattern of the customer. For example, PTL 1 discloses a means that acquires the movement path of the customer from moving image data imaged by a sensor camera and uses the movement path to know the moving pattern of the customer.

### CITATION LIST

### Patent Literature

### [PTL 1]

JP 2017-102574 A

### SUMMARY

### Technical Problem

However, in a method by which the movement path of the customer is acquired from moving image data captured by a sensor camera, etc. as described in PTL 1, for example, a blind spot in some areas in the store makes it difficult to acquire the movement path of the customer accurately.

The present disclosure provides a new and improved information processing device, information processing method, and program that may acquire the movement path of a customer in a store at a higher accuracy.

### Solution to Problem

The present disclosure provides an information processing device including a path computation unit that computes, starting from a payment position where a user entering a store pays, a movement path of the user in the store retrospectively according to time-series sensing data about the user obtained before the payment.

The present disclosure also provides an information processing method including computing, by a processor, starting from a payment position where a user entering a store pays, a movement path of the user in the store retrospectively according to time-series sensing data about the user obtained before the payment.

The present disclosure also provides a program that allows a computer to function as a path computation unit that computes, starting from a payment position where a user entering a store pays, a movement path of the user in the store retrospectively according to time-series sensing data about the user obtained before the payment.

### Advantageous Effects of Invention

As described above, according to the present disclosure, the movement path of a customer in a store may be acquired at a higher accuracy.

Note that the above effect is not necessarily limiting, and in conjunction with or instead of the above effect, any of the effects indicated in the present description or other effects that may be recognized from the present description may be provided.

### BRIEF DESCRIPTION OF DRAWINGS

FIG. 1 is an explanatory diagram illustrating an example overview of an information processing system to which a mobile communication terminal according to a first embodiment of the present disclosure is applicable.

FIG. 2 is an explanatory diagram illustrating an example store that may be applied with the information processing system to which the mobile communication terminal according to the first embodiment is applicable.

FIG. 3 is an explanatory diagram illustrating an example movement path of a user in the store.

FIG. 4 is a block diagram illustrating an example configuration of the information processing system to which the mobile communication terminal according to the first embodiment is applicable.

FIG. 5 is a sequence diagram illustrating an example operation of an information processing system to which the mobile communication terminal according to the first embodiment is applicable.

FIG. 6 is an explanatory diagram illustrating a mobile communication terminal according to a second embodiment of the present disclosure.

FIG. 7 is a block diagram illustrating an example configuration of the information processing system to which the mobile communication terminal according to the second embodiment is applicable.

FIG. 8 is a sequence diagram illustrating an example operation of the information processing system to which the mobile communication terminal according to the second embodiment is applicable.

FIG. 9 is an explanatory diagram illustrating a mobile communication terminal according to a third embodiment of the present disclosure.

FIG. 10 is a block diagram illustrating an example configuration of the information processing system to which the mobile communication terminal according to the third embodiment is applicable.

FIG. 11 is a sequence diagram illustrating an example operation of the information processing system to which the mobile communication terminal according to the third embodiment is applicable.

FIG. 12 is an example hardware configuration of an information processing device according to an embodiment of the present disclosure.

### DESCRIPTION OF EMBODIMENTS

With reference to the accompanying drawings, preferable embodiments of the present disclosure will be described in more detail below. Note that in the present description and drawings, components having substantially the same function configuration are designated with like reference numerals and repeated description thereof is omitted here.

In addition, in the present description and drawings, a plurality of components substantially having the same function configurations may be distinguished by being designated with like reference numerals followed by different alphabets. Note, however, that if it is not necessary to distinguish a plurality of components having substantially the same function configuration, the components are designated with only the same reference symbol.

Note that the description will be given in the following order.

### <1. First Embodiment>

### (1-1. Overview Information Processing System)

### (1-2. Configuration of Information Processing System)

### (1-3. Operation of Information Processing System)

### (1-4. Working Effect)

### <2. Second Embodiment>

### (2-1. Configuration of Information Processing System)

### (2-2. Operation of Information Processing System)

### (2-3. Working Effect)

### <3. Third Embodiment>

### (3-1. Configuration of Information Processing System)

### (3-2. Operation of Information Processing System)

### (3-3. Working Effect)

### <4. Modified Example>

### <5. Hardware Configuration>

### <6. Conclusion>

### 1. FIRST EMBODIMENT

### 1-1. Overview Information Processing System

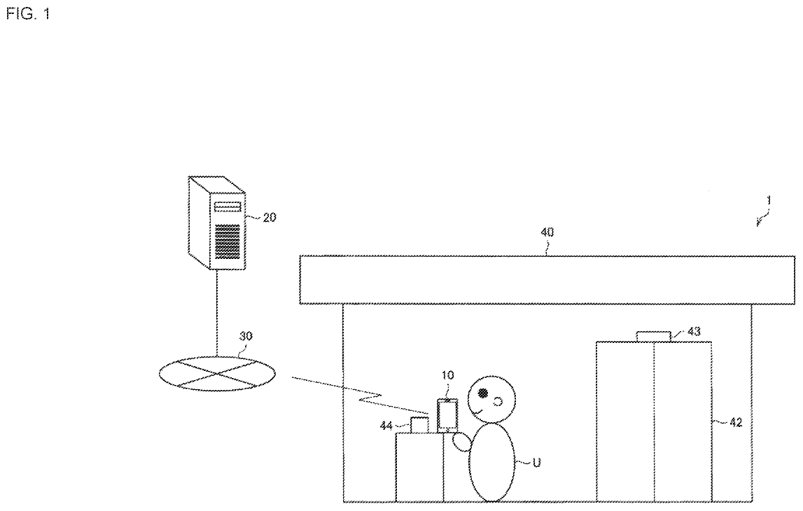

With reference to FIGS. 1 to 3, a description is given below of an overview of an information processing system to which an information processing device according to a first embodiment of the present disclosure is applicable.

FIG. 1 is an explanatory diagram illustrating an example overview of the information processing system to which the information processing device according to this embodiment is applicable. As shown in FIG. 1, an information processing system 1 includes a mobile communication terminal 10, a server 20, and a network 30. Note that in this embodiment, the mobile communication terminal 10 corresponds to the information processing device according to the present disclosure.

The mobile communication terminal 10 is a communication terminal carried by a user (customer) U. The mobile communication terminal 10 may acquire a movement path of the user U in a store 40. The mobile communication terminal 10 may also transmit and receive information from the server 20 via the network 30. Specifically, the mobile communication terminal 10 transmits to the server 20 via the network 30 movement path information indicating the movement path of the user U in the store 40. The mobile communication terminal 10 may be, but is not limited to, a mobile phone such as smartphone, a personal digital assistant (PDA) device, a tablet, or a wearable device such as a smart watch.

The server 20 stores the movement path information of the user U in the store 40. Specifically, the server 20 stores the movement path information of the user U in the store 40 received from the mobile communication terminal 10 via the network 30.

The network 30 has a function of connecting the mobile communication terminal 10 and the server 20. The network 30 may be, but is not limited to, a public network such as the Internet, a telephone network, or a satellite communication network.

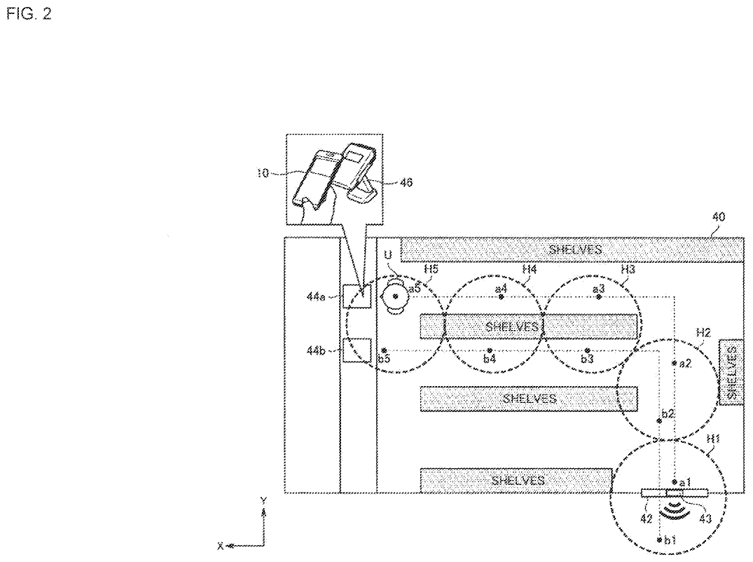

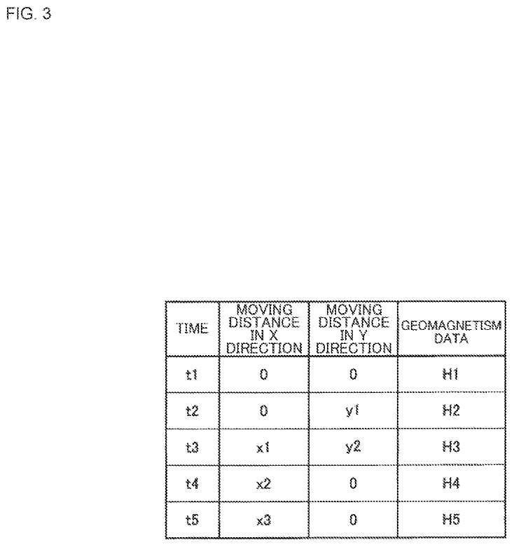

Here, with reference to FIGS. 2 to 3, reference is made to an example method by which the mobile communication terminal 10 acquires the movement path of the user U in the store 40. FIG. 2 is an explanatory diagram illustrating an example store applied with the information processing system 1 to which the mobile communication terminal 10 according to this embodiment is applicable. FIG. 3 is an explanatory diagram illustrating an example movement path of the user in the store.

As shown in FIG. 2, a wireless communication device 43 is installed near an entrance 42 of the store 40. The wireless communication device 43 may transmit a sensing start signal that triggers the mobile communication terminal 10 to start sensing of data about the user U. The wireless communication device 43 transmits the sensing start signal using a communication technology such as, for example, near field communication (for example, Bluetooth Low Energy (BLE) or Bluetooth (registered trademark)).

When the user U approaches the entrance 42 of the store 40, the mobile communication terminal 10 receives the sensing start signal transmitted from the wireless communication device 43 and starts sensing of data about the user U. An example of sensed data includes geomagnetism data indicating the intensity and direction of the geomagnetism at the locations where the user U moves in the store 40. Here, regions H1 to H5 shown by dotted lines in FIG. 2 indicate regions that have the same intensity and direction of the geomagnetism and that represent the same geomagnetism. Note that sensed data may be, but is not limited to, wireless communication data such as, for example, acceleration data, angular velocity data, atmosphere data, or Wi-fi (registered trademark) when the user U moves in the store 40. The combination of the data also may be sensed.

An example will be described below in which geomagnetism data and acceleration data and angular velocity data when the user U moves in the store 40 are sensed.

After starting sensing, the mobile communication terminal 10 continues sensing at a predetermined time interval at least until the user U pays using a payment terminal 46 provided at a register 44. Note that the payment as used herein refers to mobile payment that uses the mobile communication terminal 10 as payment means. In addition, the predetermined time interval may be set as appropriate to acquire the movement path of the user U in the store 40 and may be set to, for example, one second, etc.

FIG. 3 shows data about the movement of the user U in the store 40 when the user U moves along a path of locations a1 to a2 to a3 to a4 to a5 and pays at a register 44a as shown in FIG. 2. Here, a moving distance in the X direction and a moving distance in the Y direction shown in FIG. 3 indicate a relative distance that the user U moves in the X and Y directions shown in FIG. 2 between the time of certain sensing and the time of immediately preceding sensing. The moving direction and moving distance may be determined by subjecting acceleration data and angular velocity data sensed by the mobile communication terminal 10 to an arithmetic operation such as integral.

For example, it is shown that at time t1 (location a1) when the user U approaches the entrance 42 of the store 40 and the sensing is started, the moving distance in X and Y directions is zero and the geomagnetism data is H1. It is also shown that at time t2 when the user U moves to the location a2, the moving distance in the X direction is zero, the moving distance in the Y direction is y1, and the geomagnetism data is H2. Likewise, shown are the moving distances in the X direction, the moving distances in the Y direction, and the geomagnetism data about the user U in the store 40 up to time t5 (location a5) when the user U pays using the payment terminal 46 provided at the register 44a.

Here, an example method of acquiring the movement path of the user U in the store 40 may include a method of following data about movement of the user U in the store 40 in a time-series sequence as described above. For example, the mobile communication terminal 10 may acquire the movement path of the user U in the store 40 by storing a geomagnetism map that registers geomagnetism data at all locations in the store 40 in advance and checking the geomagnetism map and sensed geomagnetism data. Additionally, the mobile communication terminal 10 may acquire the movement path of the user U in the regions having the same intensity and direction of the geomagnetism by referring to the moving distances of the user U in the X and Y directions in the store 40 as well as geomagnetism data.

However, in the above method, it is difficult to acquire the movement path of the user U in the store 40 accurately if the sensing start location is not correctly known. Specifically, if the sensing start signal transmitted from the wireless communication device 43 reaches the same range as the region H1 shown in FIG. 2, the location where the mobile communication terminal 10 starts sensing may also be location b1 shown in FIG. 2. In that case, when the user U moves along a path of locations b1 to b2 to b3 to b4 to b5 and pays at a register 44b, the mobile communication terminal 10 senses the same data as that shown in FIG. 3. In other words, if the sensing start location is not correctly known, it is not possible to determine from data shown in FIG. 3 whether the user U moves along the path of locations a1 to a2 to a3 to a4 to a5 or the path of locations b1 to b2 to b3 to b4 to b5.

In view of the foregoing, the inventors have contemplated the embodiments of the present disclosure. According to the embodiments of the present disclosure, the movement path of the user U in the store 40 may be acquired at a higher accuracy. A description is given sequentially in more detail below of the configuration and operation of the information processing system to which the mobile communication terminal 10 according to this embodiment is applicable.

### 1-2. Configuration of Information Processing System

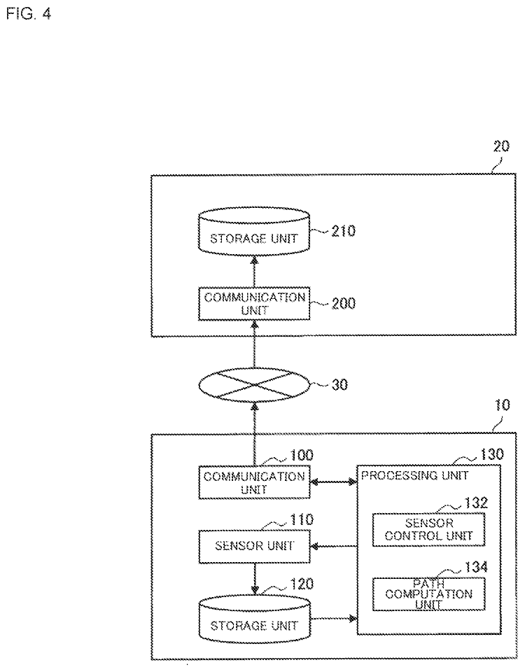

With reference to FIG. 4, a description is given below of a configuration of the information processing system 1 to which the mobile communication terminal 10 according to this embodiment is applicable. FIG. 4 is a block diagram illustrating an example configuration of the information processing system 1 to which the mobile communication terminal 10 according to this embodiment is applicable.

[1-2-1. Configuration of Mobile Communication Terminal]

As shown in FIG. 4, the mobile communication terminal 10 according to this embodiment includes a communication unit 100, a sensor unit 110, a storage unit 120, and a processing unit 130.

The communication unit 100 has a function of communicating with an external device. In communication with an external device, the communication unit 100 may output information received from the external device to the processing unit 130. Also in communication with an external device, the communication unit 100 may transmit information input from the processing unit 130 to the external device.

For example, the communication unit 100 receives the sensing start signal from the wireless communication device 43 and outputs it to a sensor control unit 132. For example, the communication unit 100 also functions as a payment position acquisition unit that acquires, from the store 40, payment position information indicating the payment position where the user U pays. The communication unit 100 also outputs the payment position information to the path computation unit 134. For example, the communication unit 100 also transmits to the server 20 the movement path information of the user U in the store 40 that is computed retrospectively by the path computation unit 134 described below. Note that the communication protocols used in the receiving or transmission may be different protocols or the same protocol.

The sensor unit 110 has a function of acquiring sensing data about the user U using various sensors. For example, the sensor unit 110 may be, but is not limited to, a sensor for sensing wireless communication data, such as an acceleration sensor, a gyro sensor, a geomagnetism sensor, an atmosphere pressure sensor, or Wi-fi.

For example, the acceleration sensor and gyro sensor are used to acquire sensing data such as acceleration data and angular velocity data when the user U moves in the store 40. In addition, the geomagnetism sensor is used to acquire sensing data such as geomagnetism data indicating the intensity and direction of the geomagnetism at the locations where the user U moves in the store 40. The sensor unit 110 outputs sensing data thus acquired to the storage unit 120.

The storage unit 120 has a function of storing externally input information. For example, the storage unit 120 may store sensing data input from the sensor unit 110. Specifically, the storage unit 120 stores acceleration data and angular velocity data, and geomagnetism data when the user U moves in the store 40. The storage unit 120 also stores the geomagnetism map that registers geomagnetism data at all locations in the store 40. Note that information stored by the storage unit 120 is not limited to the above examples and personal information of the user U, etc. may also be stored.

The processing unit 130 has a function of processing information received or acquired by the mobile communication terminal 10. As shown in FIG. 4, the processing unit 130 includes the sensor control unit 132 and the path computation unit 134.

The sensor control unit 132 has a function of controlling the sensor unit 110. The sensor control unit 132 may allow the sensor unit 110 to start or stop sensing. The sensor control unit 132 may allow the sensor unit 110 to start sensing automatically when the communication unit 100 receives the sensing start signal. In addition, the sensor control unit 132 may allow the sensor unit 110 to stop sensing automatically when the communication unit 100 receives the payment position information described below. The sensor control unit 132 may also allow the sensor unit 110 to stop sensing automatically when the user U exits the store 40.

The path computation unit 134 has a function of computing the movement path of the user U in the store 40. The path computation unit 134 computes, starting from the payment position where the user U entering the store 40 pays, the movement path of the user U in the store 40 retrospectively according to time-series sensing data about the user U obtained before the payment. With reference to FIGS. 2 to 3, a description is given below of an example method by which the path computation unit 134 computes the movement path of the user U in the store 40 retrospectively.

In FIG. 2, when the user U moves in the store 40 along the path of location a1 to location a2 to location a3 to location a4 to location a5, the sensor unit 110 senses acceleration data and angular velocity data, and geomagnetism data in a time series and stores them in the storage unit 120. The path computation unit 134 acquires data about the movement of the user U in the store 40 as shown in FIG. 3 by performing an arithmetic operation to acceleration data and angular velocity data.

Here, the payment terminal 46 provided at the register 44a previously registers, as the payment position, location a5 of the user U when payment is made using the payment terminal 46. When the user U pays by holding the mobile communication terminal 10 over the payment terminal 46, the payment terminal 46 transmits the payment position information to the mobile communication terminal 10. The payment position information uses, as the payment position of the user U, location a5 previously registered as the payment position. Note that the communication between the payment terminal 46 and the mobile communication terminal 10 may be established using a technology including, but is not limited to, a short distance wireless technology such as Near Field Communication (NFC), for example. In addition, although an example is described above in which the user U holds the mobile communication terminal 10 over the payment terminal 46, the invention is not limited thereto. For example, the same effect may also be provided if the user U pays by reading a QR code (registered trademark) displayed on the payment terminal 46 with the mobile communication terminal 10.

After acquiring the payment position information via the communication unit 100, the path computation unit 134 computes, starting from the payment position indicated by the payment position information, the movement path of the user U in the store 40 retrospectively. Specifically, when the user U pays at time t5, the path computation unit 134 determines that user U is at location a5 at time t5, which location a5 is the payment position indicated by the payment position information. Next, the path computation unit 134 computes that the location of the user U at time t4 is location a4 that is x3 distance away in the opposite direction to X from location a5 and zero distance away in the opposite direction to Y from location a5 and that has H4 of geomagnetism data registered in the geomagnetism map. Likewise, the path computation unit 134 computes locations of the user U retrospectively up to location a1 of the user U at time t1 when the user U approaches the entrance 42 of the store 40. Then, the movement path of the user U in the store is acquired by connecting the locations of the user U thus computed retrospectively in a time-series. Then, the path computation unit 134 outputs to the communication unit 100 the movement path information indicating the movement path computed retrospectively.

[1-2-2. Configuration of Server]

As shown in FIG. 4, the server 20 that is connected to the mobile communication terminal 10 according to this embodiment via the network 30 includes a communication unit 200 and a storage unit 210.

The communication unit 200 has a function of communicating with an external device. In communication with an external device, the communication unit 200 may output information received from the external device to the storage unit 210. For example, the communication unit 200 receives the movement path information of the user U in the store 40 from the mobile communication terminal 10 and outputs it to the storage unit 210.

The storage unit 210 has a function of storing the information that the communication unit 200 receives from the external device. For example, the storage unit 210 stores the movement path information that the communication unit 200 receives from the mobile communication terminal 10. Note that the information stored by the storage unit 210 is not limited to the above examples. For example, the storage unit 210 may also store personal information of the user U, etc. received from the mobile communication terminal 10.

### 1-3. Operation of Information Processing System

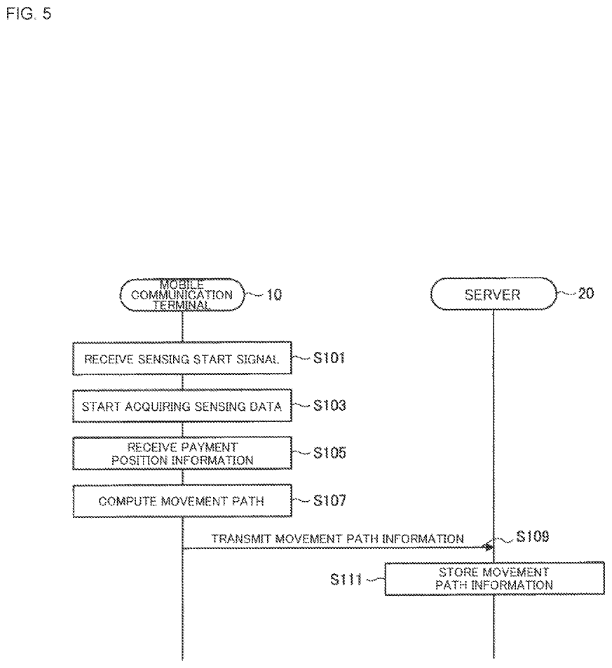

Thus, the configuration of the information processing system 1 to which the mobile communication terminal 10 according to this embodiment is applicable has been described. Next, with reference to FIG. 5, a description is given of the operation of the information processing system 1 to which the mobile communication terminal 10 according to this embodiment is applicable. FIG. 5 is a sequence diagram illustrating an example operation of the information processing system 1 to which the mobile communication terminal 10 according to this embodiment is applicable.

First, when the user U approaches the entrance 42 of the store 40, the communication unit 100 of the mobile communication terminal 10 carried by the user U receives the sensing start signal from the wireless communication device 43 (S101). The communication unit 100 outputs the received sensing start signal to the sensor control unit 132. After receiving the sensing start signal, the sensor control unit 132 automatically allows the sensor unit 110 to start acquiring sensing data about the user U (S103). The sensor unit 110 starts acquiring sensing data and outputs acquired sensing data to the storage unit 120. The storage unit 120 stores sensing data input from the sensor unit 110.

Next, when the user U pays using the payment terminal 46 provided at the register 44, the communication unit 100 receives the payment position information from the payment terminal 46 (S105). The communication unit 100 outputs the received payment position information to the path computation unit 134. After receiving the payment position information, the path computation unit 134 computes, starting from the payment position indicated by the payment position information, the movement path of the user U in the store 40 retrospectively according to sensing data stored in the storage unit 120 (S107). Then, the path computation unit 134 outputs to the communication unit 100 the movement path information indicating the movement path.

After receiving the movement path information, the communication unit 100 transmits the movement path information to the server 20 (S109). The communication unit 200 of the server 20 stores the received movement path information in the storage unit 210 (S111).

### 1-4. Working Effect

Reference is made to working effects provided by the mobile communication terminal 10 according to this embodiment. The mobile communication terminal 10 according to this embodiment computes, starting from the payment position where the user U pays, the movement path of the user U in the store 40 retrospectively according to time-series sensing data about the user U obtained before the payment. The payment position where the user U pays is highly accurate because it is the location of the user U when payment is made using the payment terminal 46. Thus, even if the sensing start location is not correctly known, the movement path of the user U in the store 40 may be acquired accurately.

In addition, the mobile communication terminal 10 according to this embodiment may automatically start and stop acquiring time-series sensing data about the user U. Thus, sensing data may be acquired without the user U recognizing start and stop of acquiring sensing data. In other words, the effort of the user U to acquire sensing data may be reduced.

### 2. SECOND EMBODIMENT

In the first embodiment, an example is described in which the payment means of the user U is the mobile payment. However, the payment means of the user U is not limited to the above example and may be a cash payment. In that case, there is no trigger to transmit the payment position information from the payment terminal 46 to the mobile communication terminal 10. The payment position information is thus not transmitted from the payment terminal 46 to the mobile communication terminal 10.

Then, a description is given below of a second embodiment of the present disclosure in which the movement path of the user U in the store 40 may be acquired at a higher accuracy even if the payment means of the user U is the cash payment and thus the payment position information is not acquired from the payment terminal 46. Note that in this embodiment, a mobile communication terminal 11 corresponds to the information processing device according to the present disclosure. In addition, basically, description overlapped with that in the first embodiment will be omitted below and the difference from the first embodiment will be described.

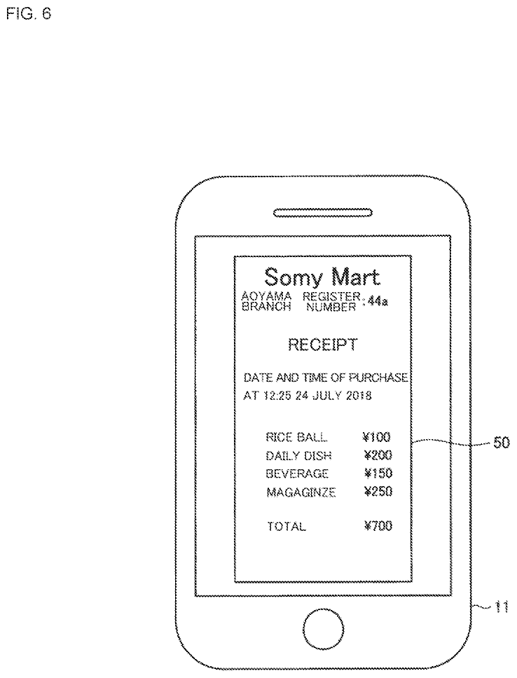

First, with reference to FIG. 6, an overview of the mobile communication terminal 11 according to this embodiment will be described. FIG. 6 is an explanatory diagram illustrating the mobile communication terminal 11 according to this embodiment.

FIG. 6 shows a receipt 50 that includes store information indicating the store that the user U enters (Aoyama branch in FIG. 6), register information indicating the register where payment is made (44a in FIG. 6), and the payment time when payment is made (at 12:25 on 24 Jul. 2018 in FIG. 6). Before making the cash payment, the user U receives the receipt 50.

The mobile communication terminal 11 according to this embodiment may estimate the payment position in time-series sensing data about the user U, according to at least either of the store information or register information and the payment time. The mobile communication terminal 11 may also compute, starting from the payment position thus estimated in time-series sensing data about the user U, the movement path of the user U in the store 40 retrospectively.

### 2-1. Configuration of Information Processing System

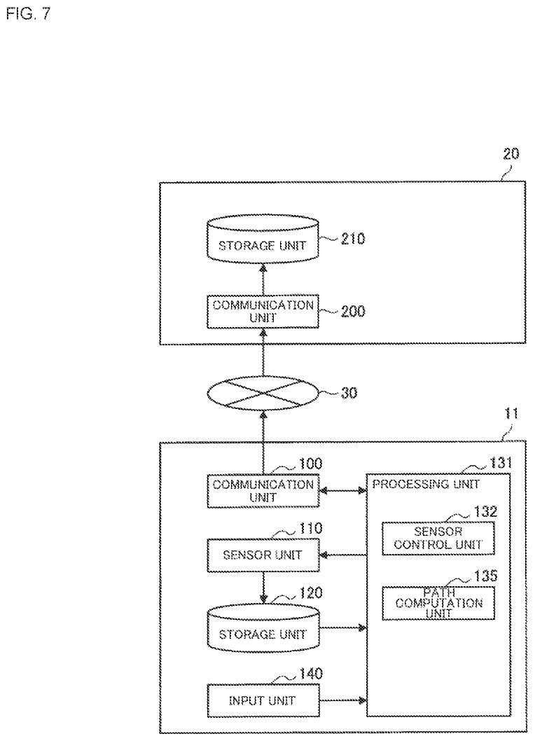

Next, with reference to FIG. 7, a description is given of a configuration of an information processing system to which the mobile communication terminal 11 according to this embodiment is applicable. FIG. 7 is a block diagram illustrating an example configuration of the information processing system to which the mobile communication terminal 11 according to this embodiment is applicable. As shown in FIG. 7, the mobile communication terminal 11 according to this embodiment includes the communication unit 100, the sensor unit 110, the storage unit 120, a processing unit 131, and an input unit 140. The communication unit 100, the sensor unit 110, and the storage unit 120 function as described in the first embodiment and their detailed description is omitted here. The configuration and function of the server 20 are also as described in the first embodiment and their detailed description is omitted here.

The processing unit 131 has a function of processing information received or acquired by the mobile communication terminal 11. The processing unit 131 includes the sensor control unit 132 and a path computation unit 135. The sensor control unit 132 functions as described in the first embodiment and its detailed description is omitted here. Note that in this embodiment, the sensor control unit 132 allows the sensor unit 110 to stop sensing when the user U exits the store 40. In other words, in this embodiment, time-series sensing data about the user U is data from when the user U approaches the entrance 42 of the store 40 to when the user U exits the store 40.

In addition to the function of the path computation unit 134 in the first embodiment, the path computation unit 135 further has a function as a payment position estimation unit of estimating the payment position in time-series sensing data about the user U, according to at least either of the store information or register information and the payment time.

For example, if the input unit 140 is a camera, then the path computation unit 134 subjects an image of the receipt 50 imaged by the input unit 140 to well-known image recognition processing. The path computation unit 134 thus acquires the store information, register information, and payment time that are described in the receipt 50. Note that the means by which the path computation unit 134 acquires the store information, register information, and payment time is not limited to the above example. For example, if the input unit 140 is a keyboard, the path computation unit 134 may acquire the store information, register information, and payment time that are input by the user U typing on the keyboard with reference to the receipt 50.

Note that if the register information is set such that the register information does not overlap between a plurality of stores, the path computation unit 134 may not acquire the store information. In addition, if only one register is provided in the store 40, the path computation unit 134 may not acquire the register information.

Here, in this embodiment, the storage unit 120 stores the store information and the payment position information that is associated with the register information. For example, the storage unit 120 stores information indicating that if the store information is “Aoyama branch” and the register information is “44a”, then the payment position is “location a5”. Therefore, if the receipt 50 includes the store information of “Aoyama branch” and the register information of “44a”, the path computation unit 134 may know that the payment position is “location a5”.

By associating the payment position thus known with time-series sensing data about the user U, the path computation unit 134 estimates the payment position in time-series sensing data about the user U. In that case, the path computation unit 134 performs the association according to the payment time. For example, if the payment time is “at 12:25 24 July 2018”, and time t5 shown in FIG. 3 is “at 12:25 24 July 2018”, then the path computation unit 134 estimates that the location at time t5 shown in FIG. 3 is the payment position of “location a5”.

By using the payment position thus estimated in time-series sensing data about the user U as the payment position information, the path computation unit 134 computes the movement path of the user U in the store 40 retrospectively as in the first embodiment.

The input unit 140 has a function of acquiring information outside the mobile communication terminal 11. For example, the input unit 140 may be provided by a device for the user to input information, such as a camera, a keyboard, a touch panel, a button, and a microphone installed in the mobile communication terminal 11.

### 2-2. Operation of Information Processing System

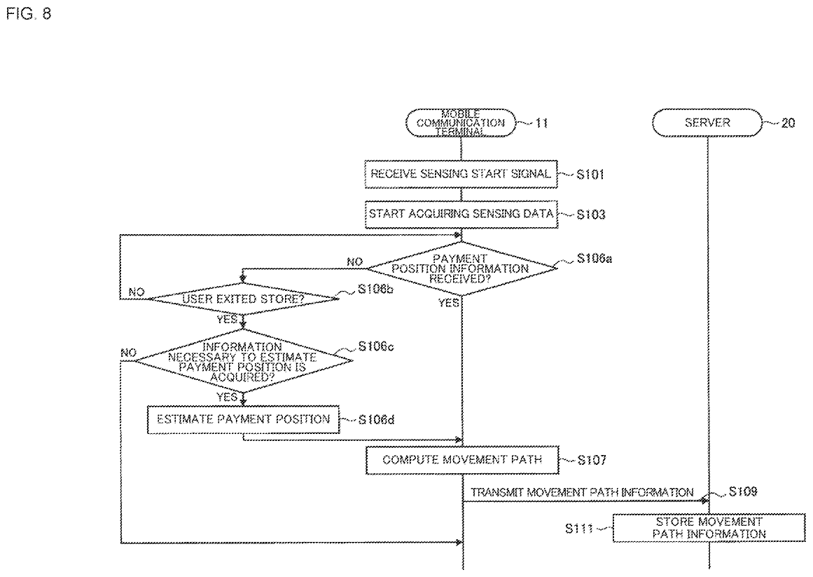

Thus, the configuration of the information processing system to which the mobile communication terminal 11 according to this embodiment is applicable has been described. Next, with reference to FIG. 8, a description is given of an operation of the information processing system to which the mobile communication terminal 11 according to this embodiment is applicable. FIG. 8 is a sequence diagram illustrating an example operation of the information processing system to which the mobile communication terminal according to this embodiment is applicable.

In the example shown in FIG. 8, the processes in steps S101 to S103 are as described in the first embodiment and their detailed description is omitted here. In this embodiment, after the process in step S103 is started, the path computation unit 134 determines whether the communication unit 100 receives the payment position information from the payment terminal 46 (S106a). If the communication unit 100 does not receive the payment position information from the payment terminal 46 (S106a/No), then the path computation unit 134 determines whether the user U exits the store 40 (S106b). For example, whether the user U exits the store 40 may be determined by determining whether the communication unit 100 re-receives the sensing start signal from the wireless communication device 43.

If it is determined that the user U exits the store 40 (S106b/Yes), then the path computation unit 134 determines whether information necessary to estimate the payment position is acquired (S106c). Here, the information necessary to estimate the payment position may be, for example, the above store information, register information, and payment time. If the information necessary to estimate the payment position is acquired (S106c/Yes), then the path computation unit 134 estimates the payment position in time-series sensing data about the user U (S106d) and goes to step S107 using the estimated payment position as the payment position information. Note that the processes in steps S107 to S111 are as described in the first embodiment and their detailed description is omitted here.

### 2-3. Working Effect

Reference is made to working effects provided by the mobile communication terminal 11 according to this embodiment. Even if the payment means is the cash payment, the mobile communication terminal 11 according to this embodiment may compute, starting from the payment position where the user U pays, the movement path of the user U in the store 40 retrospectively according to time-series sensing data about the user U obtained before the payment. Thus, even if the sensing start location is not correctly known, the movement path of the user U in the store 40 may be acquired accurately.

### 3. THIRD EMBODIMENT

In the first and second embodiments, a description is given of the information processing device according to the present disclosure that may acquire the movement path of the user U in the store 40 accurately even if the sensing start location is not correctly known. With the movement path disclosed to the store 40 by the information processing device, the store 40 may know the purchase tendency and behavior pattern of the user U.

However, it may be unfavorable for the personal information of the user U including the movement path to be disclosed to the store 40. For example, the user U does not know what information is disclosed to the store 40 and personal information that the user U does not intend to disclose may be disclosed to the store 40.

Then, a description is given of a third embodiment of the present disclosure that may disclose to the store 40 only personal information intended by the user U. Note that in this embodiment, a mobile communication terminal 12 corresponds to the information processing device according to the present disclosure. In addition, basically, description overlapped with that in the first and second embodiments will be omitted below and the difference from the first and second embodiments will be described.

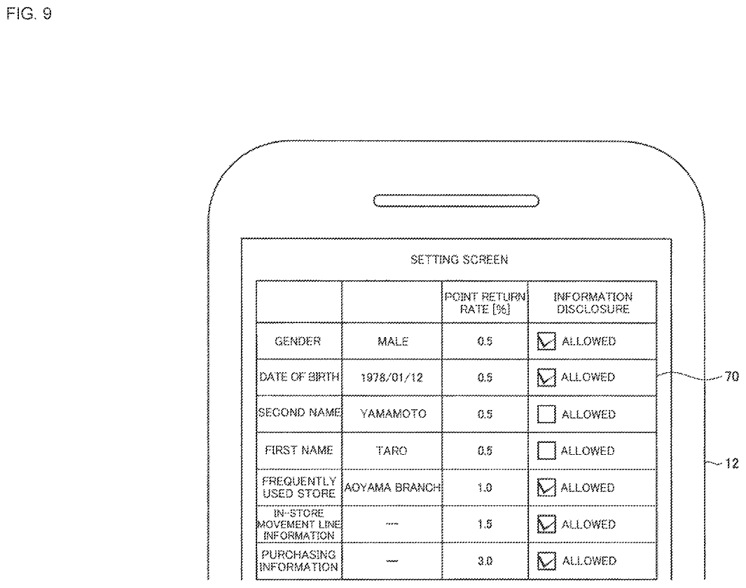

First, with reference to FIG. 9, an overview of the mobile communication terminal 12 according to this embodiment will be described. FIG. 9 is an explanatory diagram illustrating the mobile communication terminal 12 according to this embodiment. As shown in FIG. 9, the mobile communication terminal 12 may display a setting screen 70 for setting whether to allow disclosure of the personal information to the store 40. The user U sets in advance whether to allow the mobile communication terminal 12 to disclose, to the store 40, the personal information displayed on the setting screen 70 (such as “gender”, “date of birth”, “second name”, “first name”, “frequently used store”, “in-store movement line information (the movement path information in this embodiment)”, and “purchasing information”, etc.),

Here, the purchasing information is information that indicates what and how much the user U purchases at the time of payment.

The mobile communication terminal 12 according to this embodiment may disclose to the store 40 only the personal information that is allowed by the user U to be disclosed to the store 40 in the above setting and may not disclose to the store 40 the personal information that is not allowed by the user U to be disclosed to the store 40. A description is given sequentially in more detail below of a configuration and an operation of the information processing system to which the mobile communication terminal 12 according to this embodiment is applicable.

### 3-1. Configuration of Information Processing System

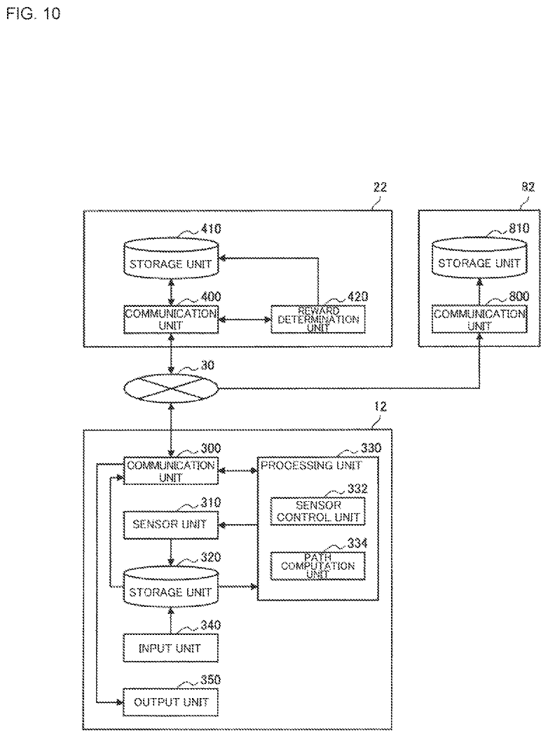

With reference to FIG. 10, a description is given below of a configuration of the information processing system to which the mobile communication terminal 12 according to this embodiment is applicable. FIG. 10 is a block diagram illustrating an example configuration of the information processing system to which the mobile communication terminal 12 according to this embodiment is applicable. The information processing system to which the mobile communication terminal 12 according to this embodiment is applicable includes the mobile communication terminal 12, a server 22, the network 30, and a store side terminal 82.

[3-1-1. Configuration of Mobile Communication Terminal]

As shown in FIG. 10, the mobile communication terminal 12 according to this embodiment includes a communication unit 300, a sensor unit 310, a storage unit 320, a processing unit 330, an input unit 340, and an output unit 350. The configurations and functions of the sensor unit 310, storage unit 320, processing unit 330, and input unit 340 are the same as those of the sensor unit 110, storage unit 120, processing unit 130, and input unit 140 in the first or second embodiment, respectively, and their detailed description is omitted here. Note that in FIG. 10, the sensor control unit 332 and path computation unit 334 included in the processing unit 330 correspond to the sensor control unit 132 and path computation unit 134 included in the processing unit 130 in FIG. 4, respectively.

In addition to the function of the communication unit 100 in the first embodiment, the communication unit 300 further has a function as an information disclosure unit of disclosing to the store 40 the personal information of the user U including the movement path of the user U in the store 40. The communication unit 300 also has a function of disclosing the personal information to the store 40 if the user U allows the disclosure of the personal information to the store 40 and not disclosing the personal information to the store 40 if the user U does not allow the disclosure of the personal information to the store 40.

For example, if the user U allows the disclosure of the personal information to the store 40, the communication unit 300 transmits to the server 22 information of the user U that is input by the input unit 340 and stored in the storage unit 320, and personal information including the movement path information of the user U in the store 40 that is computed by the path computation unit 334. Here, if the user U allows the disclosure of only some of a plurality of sets of personal information to the store 40, the communication unit 300 may transmit only the some sets of personal information to the server 22.

The fact that the user U pays may trigger the communication unit 300 to transmit the personal information to the server 22. The personal information transmitted to the server 22 is further transmitted to the store side terminal 82 described below and then disclosed to the store 40. The note that the communication unit 300 may transmit the personal information to the store side terminal 82 while transmitting the personal information to the server 22.

Note that the personal information may include a plurality sets of information including, but are not limited to, “gender”, “date of birth”, “second name”, “first name”, “frequently used store”, “in-store movement line information”, and “purchasing information”. The mobile communication terminal 12 may store picture data, music data, Internet browsing history data or search history data, SNS information such as ID corresponding to Social Networking Service (SNS), outdoor position information or indoor position information acquired by Global Positioning System (GPS), etc., movement history data by public transportation means, application data installed in the mobile communication terminal 12, and various ID data, etc.

Here, in this embodiment, when the mobile communication terminal 12 discloses the personal information to the store 40, the user U is provided with a reward such as a point. The point given to the user U is determined according to a point return rate preset by the store 40 depending on the type of the personal information. Note that the point return rate is the ratio of points provided by the store 40 to the amount of money that the user U pays at the time of payment. The store 40 may set the point return rate depending on the priority of the personal information that they want to acquire. For example, if the store 40 wants to acquire the purchasing information of the user U the most, they may set the highest point return rate to the purchasing information.

Referring to the point return rate set to each set of the personal information, the user U may determine whether to allow the disclosure of the personal information. For example, if the user U wants to get more points, the user U may set to allow the disclosure of the personal information with a relatively high point return rate or set to allow the disclosure of all personal information. Meanwhile, if the user U wants to disclose none of the personal information, the user U may set to allow none of the personal information to be disclosed.

The output unit 350 has a function of outputting characters and voices, and images, etc. The output unit 350 may be provided by a device that outputs information to the user, such as a liquid crystal screen or a speaker installed in the mobile communication terminal 12. For example, the output unit 350 displays the setting screen 70 shown in FIG. 9 to the user U.

Referring to the displayed setting screen 70, the user U sets whether to allow the mobile communication terminal 12 to disclose, to the store 40, the personal information such as “gender”, “date of birth”, “second name”, “first name”, “frequently used store”, “in-store movement line information”, and “purchasing information”.

The output unit 350 also has a function as a reward display unit of displaying the reward such as the point given to the user U when the user U discloses the personal information to the store 40. When the communication unit 300 receives from the server 22 point information indicating the point given to the user U, the output unit 350 displays the point indicated by the point information on the display screen of the mobile communication terminal 12.

[3-1-2. Configuration of Server]

As shown in FIG. 10, the server 22 connected to the mobile communication terminal 12 according to this embodiment via the network 30 includes a communication unit 400, a storage unit 410, and a reward determination unit 420. The storage unit 410 functions the same as the storage unit 210 in the first embodiment, and its detailed description is omitted here.

The communication unit 400 functions the same as the communication unit 200 in the first embodiment. Note, however, that the communication unit 400 may transmit the point information input from the reward determination unit 420 to the mobile communication terminal 12. The communication unit 400 may also transmit the personal information received from the mobile communication terminal 12 further to the store side terminal 82.

The reward determination unit 420 has a function of determining the point given to the user U depending on the type of the input personal information. For example, the reward determination unit 420 determines the point given to the user U by multiplying the point return rate preset by the store 40 for the personal information that the communication unit 400 receives from the mobile communication terminal 12 by the amount of money that the user U pays at the time of payment. Here, the reward determination unit 420 may acquire the amount of money that the user U pays at the time of payment from, for example, the payment terminal 46 or store side terminal 82. The reward determination unit 420 outputs the point information indicating the point given to the user U thus determined to the communication unit 400 and storage unit 410.

[3-1-3. Configuration of Store Side Terminal]

The store side terminal 82 is a terminal provided in the store 40 and stores the personal information of the user U. Specifically, the store side terminal 82 stores the personal information of the user U that is received from the server 22 via the network 30. As shown in FIG. 10, the store side terminal 82 includes a communication unit 800 and a storage unit 810.

The communication unit 800 has a function of communicating with an external device. In communication with an external device, the communication unit 800 may output the information received from the external device to the storage unit 810. For example, the communication unit 800 receives the personal information of the user U from the server 22.

The storage unit 810 has a function of storing the information that the communication unit 800 receives from the external device. The storage unit 810 may store the personal information of the user U that the communication unit 800 receives from the server 22.

### 3-2. Operation of Information Processing System

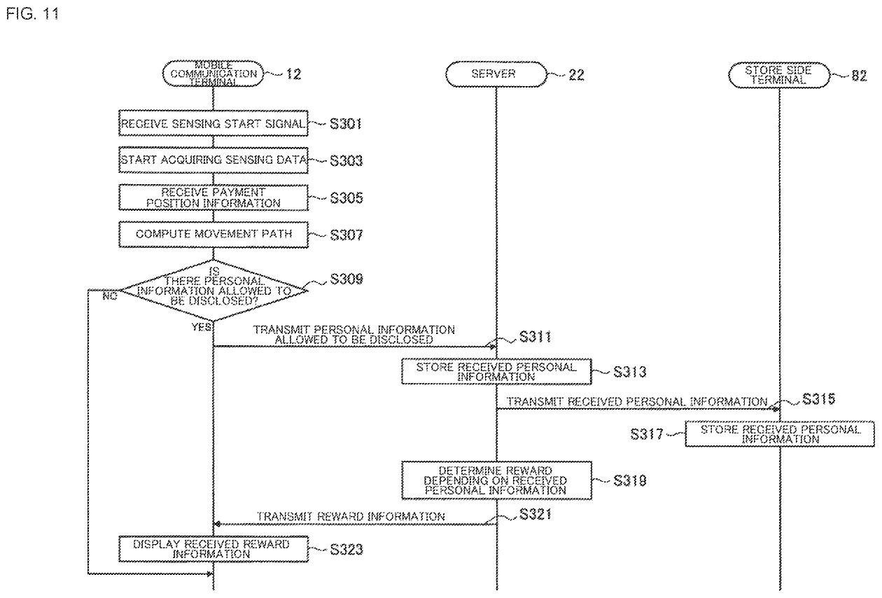

Thus, the configuration of the information processing system to which the mobile communication terminal 12 according to this embodiment is applicable has been described. Next, with reference to FIG. 11, a description is given of an operation of the information processing system to which the mobile communication terminal 12 according to this embodiment is applicable. FIG. 11 is a sequence diagram illustrating an example operation of the information processing system to which the mobile communication terminal according to this embodiment is applicable.

In the example shown in FIG. 11, the processes in steps S301 to S307 are the same as the steps S101 to S107 described in the first embodiment, and their detailed description is omitted here. In this embodiment, after the process in step S307 is complete, the communication unit 300 determines whether there is personal information allowed by the user U to be disclosed to the store 40 (S309). If there is personal information allowed by the user U to be disclosed to the store 40 (S309/Yes), the communication unit 300 transmits the personal information to the server 22 (S311).

The communication unit 400 of the server 22 stores the received personal information in the storage unit 410 (S313). The communication unit 400 also transmits the received personal information to the store side terminal 82 (S315). The communication unit 800 of the store side terminal 82 stores the received personal information in the storage unit 810 (S317). The communication unit 400 also outputs the received personal information to the reward determination unit 420. Depending on the type of the input personal information, the reward determination unit 420 determines the point that is the reward given to the user U (S319). The reward determination unit 420 stores the point information indicating the determined point in the storage unit 410 and also transmits the point information to the mobile communication terminal 12 (S321). The communication unit 300 of the mobile communication terminal 12, which receives the point information, outputs the point information to the output unit 350. After receiving the point information, the output unit 350 displays the point indicated by the point information (S323).

### 3-3. Working Effect

Reference is made to working effects provided by the mobile communication terminal 12 according to this embodiment. The mobile communication terminal 12 according to this embodiment discloses to the store 40 only the personal information that is allowed by the user U to be disclosed to the store 40. Thus, the personal information that the user U does not intend to disclose is not disclosed to the store 40.

In addition, the mobile communication terminal 12 according to this embodiment allows the user U to obtain the point depending on the type of the personal information that is allowed to be disclosed to the store 40. In other words, for each set of the personal information, the user U may select whether the user U discloses the personal information and obtains the point or the user U does not disclose the personal information and not obtain the point.

In addition, in the information processing system to which the mobile communication terminal 12 according to this embodiment is applicable, the store 40 sets the point return rate depending on the priority of the personal information that they want to acquire. Thus, the store 40 may preferentially acquire high priority personal information. In other words, the store 40 may control the personal information to be acquired.

### 4. MODIFIED EXAMPLES

Modified examples of the information processing device according to the embodiments of the present disclosure will be described below. Note that the modified examples described below may be applied to the embodiments of the present disclosure alone or applied to the embodiments of the present disclosure in combination. In addition, the modified examples may be applied instead of the configurations described in the embodiments of the present disclosure or applied in addition to the configurations described in the embodiments of the present disclosure.

### 4-1. First Modified Example

In the first embodiment, an example is described in which the mobile communication terminal corresponds to the information processing device according to the present disclosure, but the server may correspond to the information processing device according to the present disclosure. In other words, the server may have a function that corresponds to the path computation, i.e., a function as the information processing device according to the present disclosure. In that case, the time-series sensing data about the user U acquired by the mobile communication terminal and the payment position information received by the mobile communication terminal are transmitted to the server without being processed by the mobile communication terminal. Then, the function included in the server that corresponds to the path computation unit computes the movement path of the user U in the store 40 retrospectively.

As described above, even if the server corresponds to the information processing device according to the present disclosure, the movement path of the user U in the store 40 may be computed, starting from the payment position where the user U pays, retrospectively, according to time-series sensing data about the user U obtained before the payment. Thus, even if the sensing start location is not correctly known, the movement path of the user U in the store 40 may be acquired accurately.

In addition, in this modified example, the server computes the movement path, so the mobile communication terminal may not include the path computation unit and the mobile communication terminal may not store the geomagnetism map. In other words, the mobile communication terminal may experience less load.

### 4-2. Second Modified Example

In the first embodiment, an example is described in which the payment means is mobile payment, but the payment means may be a card payment. If the payment means is the card payment, the mobile communication terminal previously stores card information (for example, a card number) to identify a card used for payment. For example, when the user U carrying the mobile communication terminal enters the store 40 and holds a card for payment over the payment terminal 46 or inserts the card for payment in the payment terminal 46 for card payment, the payment terminal 46 transmits the payment position information to the mobile communication terminal that registers the card information used for payment. After acquiring the payment position information, the mobile communication terminal computes the movement path of the user U in the store 40 retrospectively as in the above embodiments.

As described above, even if the payment means is the card payment, the movement path of the user U in the store 40 may be computed, starting from the payment position where the user U pays, retrospectively, according to time-series sensing data about the user U obtained before the payment. Thus, even if the sensing start location is not correctly known, the movement path of the user U in the store 40 may be acquired accurately.

### 4-3. Third Modified Example

In the second embodiment, an example is described in which if the payment means is the cash payment, the payment position in time-series sensing data about the user U may be estimated using the receipt 50, but the payment position in time-series sensing data about the user U may be estimated without using the receipt 50. For example, the path computation unit may estimate the payment position in time-series sensing data about the user U according to the movement state of the user U in time-series sensing data about the user U.

Generally, the user U needs to stop at the payment position for payment. In addition, generally, the user U after payment exits the store without stopping. Therefore, for example, the path computation unit may estimate, back from the last time in time-series sensing data about the user U (in other words, the time when the user U exits the store 40), the location where the user U stops (in other words, is not moving) longer than a predetermined amount of time for the first time, as the payment position.

As described above, even if the payment means is the cash payment, the payment position in time-series sensing data about the user U may be estimated without using the receipt 50. Therefore, the movement path of the user U in the store 40 may be computed, starting from the payment position where the user U pays, retrospectively, according to time-series sensing data about the user U obtained before the payment. Thus, even if the sensing start location is not correctly known, the movement path of the user U in the store 40 may be acquired accurately.

### 4-4. Fourth Modified Example

In the third embodiment, an example is described in which when the user U pays, the user U is provided with a point by disclosing to the store 40 the personal information including the retrospectively computed movement path of the user U in the store 40. However, even if the user U does not pay, the user U may be provided with a point by disclosing the personal information of the user U to the store 40.

For example, even if the personal information does not include the retrospectively computed movement path of the user U in the store 40 because the user U does not pay, the user U may be provided with a point if the information about the movement of the user U in the store 40 is disclosed to the store 40. Here, the information about the movement of the user U in the store 40 may be, for example, time-series sensing data sensed by the mobile communication terminal, such as acceleration data and angular velocity data, or magnetic data when the user U moves in the store 40. In that case, the information disclosed to the store 40 that represents the movement path has a lower accuracy than the retrospectively computed movement path. Note, however, that the store 40 may know the purchase tendency and behavior pattern of the user U that does not pay (in other words, does not purchase) by acquiring information that represents the movement path of the user U, and so the store 40 may provide the user U with a predetermined point, as a reward, that is determined in advance. The store 40 may also provide the user U with a point when any personal information of the user U is disclosed to the store 40 in addition to the information about the movement of the user U in the store 40.

As described above, in this modified example, even if the user U does not pay, the user U is provided with a point by disclosing the personal information of the user U to the store 40. Thus, the user U may acquire a point even if the user U does not purchase in the store 40. In addition, the store 40 may acquire the personal information of the user U that does not purchase.

### 5. HARDWARE CONFIGURATION

Thus, the embodiments of the present disclosure have been described. The above information processing such as the retrospective computation of the movement path may be provided by cooperation of software and hardware of an information processing device that includes a mobile communication terminal and a server as described below.

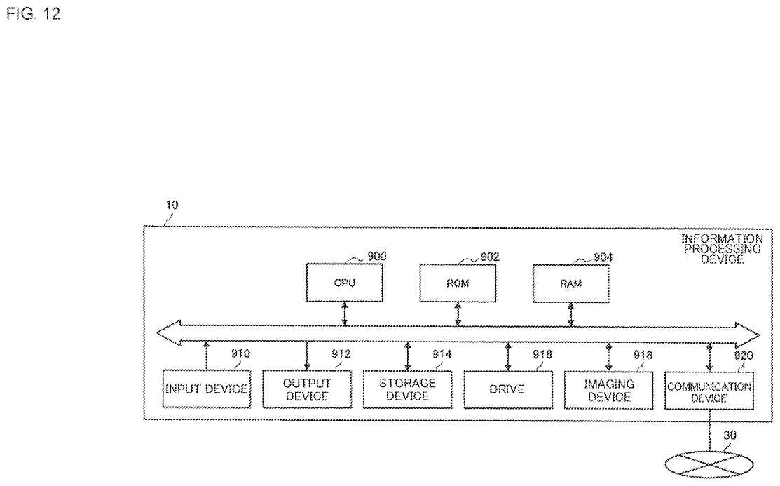

FIG. 12 is an explanatory diagram illustrating hardware configuration of the information processing device. As shown in FIG. 12, the information processing device includes a Central Processing Unit (CPU) 900, a Read Only Memory (ROM) 902, a Random Access Memory (RAM) 904, an input device 910, an output device 912, a storage device 914, a drive 916, an imaging device 918, and a communication device 920.

The CPU 900 functions as an arithmetic processing unit and a control device. The CPU 900 controls the whole operation of the information processing device according to various programs. The CPU 900 may also be a microprocessor. The ROM 902 stores a program and an operation parameter, etc. that are used by the CPU 900. The RAM 904 temporarily stores a program used in the execution of the CPU 900 and a parameter changed appropriately in the execution. Those are interconnected by a host bus that includes a CPU bus, etc. Cooperation between the CPU 900, ROM 902, and RAM 904 and the software may provide a function such as the sensor control unit 132 and path computation unit 134.

The input device 910 includes input means by which the user inputs information (such as a mouse, a keyboard, a touch panel, a button, a microphone, a switch, and a lever) and an input control circuit that generates an input signal in response to the user input and outputs it to the CPU 900, etc. The user of the information processing device may input various data and indicate processing operation to the information processing device by operating the input device 910.

The output device 912 may include a display device such as, for example, a liquid crystal display (LCD) device and an Organic Light Emitting Diode (OLED) device. For example, the display device displays a character string input from the input device 910, etc.

The storage device 914 is a device for storing various data. The storage device 914 may include a storage medium, a storage device that records data in the storage medium, a reading device that reads data from the storage medium, and a deletion device that deletes data recorded in the storage medium, etc. The storage device 914 includes, for example, a semiconductor storage device, an optical storage device, a hard disk drive (HDD) magnetic storage device, or magneto-optical storage device, etc.

The drive 916 is a reader/writer for the storage medium. The drive 916 is built in or externally attached to the information processing device. The drive 916 reads information recorded in a removable storage medium such as a mounted semiconductor memory, a magnetic disk, an optical disk, or a magneto-optical disk and outputs it to the RAM 904. The drive 916 may also write information in the removable storage medium.

The imaging device 918 includes an imaging optical system such as a photographing lens for collecting light and a zoom lens, and a signal conversion device such as Charge Coupled Device (CCD) or Complementary Metal Oxide Semiconductor (CMOS). The imaging optical system collects light emitted from the subject and forms a subject image in a signal conversion unit. The signal conversion device converts the formed subject image to an electrical image signal.

The communication device 920 is a communication interface that includes, for example, a communication device to communicate with the wireless communication device 43 or network 30, etc. The communication device 920 may be a Bluetooth Low Energy (BLE) enabled communication device, a Bluetooth (registered trademark) enabled communication device, a wireless Local Area Network (LAN) enabled communication device, or a Long Term Evolution (LTE) enabled communication device.

### 6. CONCLUSION

As described above, according to the embodiments of the present disclosure, the movement path of a customer in a store may be acquired at a higher accuracy.

Thus, the preferred embodiments of the present disclosure have been described in detail with reference to the accompanying drawings, but the scope of the present disclosure is not limited thereto. It is apparent that one of ordinary skill in the art of the present disclosure may readily conceive of various changes or modifications within the scope of the technical concept described in the claims, and all such changes or modifications are of course intended to be included within the scope of the present disclosure.

For example, the steps in the above embodiments need not necessarily be processed in a time series in the order described as the sequence diagram. For example, the steps in the processing in the above embodiments may be processed in a different order from the order described as the sequence diagram or may be processed in parallel.

In addition, the working effects described in the present description are merely explanatory or illustrative and not limiting. In other words, in conjunction with or instead of the above working effects, the technology according to the present disclosure may provide other working effects apparent to those skilled in the art from the description of the present description.

A computer program may also be provided for allowing hardware such as CPU, ROM, and RAM installed in the mobile communication terminal or server to provide functions equivalent to the configurations of the mobile communication terminal or server. In addition, a storage medium storing the computer program may be provided.

Note that the following configurations also belong to the scope of the present disclosure.

(1)

An information processing device including a path computation unit that computes, starting from a payment position where a user entering a store pays, a movement path of the user in the store retrospectively according to time-series sensing data about the user obtained before the payment.

(2)

The information processing device according to (1), further including a payment position acquisition unit that acquires, from the store, payment position information that indicates the payment position at time of the payment, wherein the path computation unit computes the movement path, starting from the payment position indicated by the payment position information acquired by the payment position acquisition unit from the store.

(3)

The information processing device according to (1) or (2), further including a payment position estimation unit that estimates the payment position from the time-series sensing data according to payment time when the payment is made and at least either of store information that indicates a store entered by the user or register information that indicates a register where the payment is made is made, wherein the path computation unit computes the movement path starting from the payment position estimated by the payment position estimation unit.

(4)

The information processing device according to (3), wherein the store information, the register information, and the payment time are acquired from a captured image of a receipt received by the user at the time of payment.

(5)

The information processing device according to (3), wherein the payment position estimation unit estimates a movement state of the user from the time-series sensing data even if at least any one of the store information, the register information, or the payment time is not acquired, and estimates that the payment position is the position of the user when the movement state of the user is in a specific state.

(6)

The information processing device according to any one of (1) to (5), further including an information disclosure unit that discloses, to the store, personal information of the user including the movement path.

(7)

The information processing device according to (6), wherein the information disclosure unit discloses the personal information to the store if the user allows the disclosure of the personal information to the store.

(8)

The information processing device according to any one of (1) to (7), wherein the sensing data includes at least any one of acceleration data, angular velocity data, geomagnetism data, atmosphere data, or wireless communication data.

(9)

The information processing device according to any one of (1) to (8), wherein the information processing device is a mobile communication terminal carried by the user and the sensing data is collected by a sensor installed in the mobile communication terminal.

(10)

The information processing device according to (9), further including a sensor control unit that automatically starts collecting the sensing data when the user enters the store.

(11)

The information processing device according to (10), wherein receiving a sensing start signal generated by a wireless communication device installed near an entrance of the store triggers the sensor control unit to start collecting the sensing data.

(12)

The information processing device according to any one of (6) to (11), further including a reward display unit that displays a reward given to the user when the personal information is disclosed to the store.

(13)

The information processing device according to (12), wherein the reward is determined according to a reward return rate preset by the store depending on a type of the personal information.

(14)

The information processing device according to (12) or (13), wherein the reward is given to the user when information about a movement of the user in the store is disclosed to the store even if the personal information does not include the movement path because the user does not make the payment.

(15)

The information processing device according to any one of (6) to (8), wherein the information processing device is a server connected via a network to a mobile communication terminal carried by the user and further includes a reward determination unit that determines a reward given to the user when the personal information is disclosed to the store.

(16)

An information processing method including computing, by a processor, starting from a payment position where a user entering a store pays, a movement path of the user in the store retrospectively according to time-series sensing data about the user obtained before the payment.

(17)

A program that allows a computer to function as a path computation unit that computes, starting from a payment position where a user entering a store pays, a movement path of the user in the store retrospectively according to time-series sensing data about the user obtained before the payment.

### REFERENCE SIGNS LIST

1 Information processing system
10, 11, 12 Mobile communication terminal
20, 22 Server
30 Network
40 Store
43 Wireless communication device
44 Register
46 Payment terminal
82 Store side terminal
100, 200, 300, 400, 800 Communication unit
110, 310 Sensor unit
120, 210, 320, 410, 810 Storage unit
130, 131, 330 Processing unit
132, 332 Sensor control unit
134, 135, 334 Path computation unit
140, 340 Input unit
350 Output unit
420 Reward determination unit
U User

1. An information processing device comprising a path computation unit that computes, starting from a payment position where a user entering a store pays, a movement path of the user in the store retrospectively according to time-series sensing data about the user obtained before the payment.

2. The information processing device according to claim 1, further comprising a payment position acquisition unit that acquires, from the store, payment position information that indicates the payment position at time of the payment, wherein the path computation unit computes the movement path, starting from the payment position indicated by the payment position information acquired by the payment position acquisition unit from the store.

3. The information processing device according to claim 1, further comprising a payment position estimation unit that estimates the payment position from the time-series sensing data according to payment time when the payment is made and at least either of store information that indicates a store entered by the user or register information that indicates a register where the payment is made, wherein the path computation unit computes the movement path starting from the payment position estimated by the payment position estimation unit.

4. The information processing device according to claim 3, wherein
the store information, the register information, and the payment time are acquired from a captured image of a receipt received by the user at the time of payment.

5. The information processing device according to claim 3, wherein
the payment position estimation unit estimates a movement state of the user from the time-series sensing data even if at least any one of the store information, the register information, or the payment time is not acquired, and estimates that the payment position is the position of the user when the movement state of the user is in a specific state.

6. The information processing device according to claim 1, further comprising an information disclosure unit that discloses, to the store, personal information of the user comprising the movement path.

7. The information processing device according to claim 6, wherein
the information disclosure unit discloses the personal information to the store if the user allows the disclosure of the personal information to the store.

8. The information processing device according to claim 1, wherein the sensing data comprises at least any one of acceleration data, angular velocity data, geomagnetism data, atmosphere data, or wireless communication data.

9. The information processing device according to claim 1, wherein the information processing device is a mobile communication terminal carried by the user and the sensing data is collected by a sensor installed in the mobile communication terminal.

10. The information processing device according to claim 9, further comprising a sensor control unit that automatically starts collecting the sensing data when the user enters the store.

11. The information processing device according to claim 10, wherein receiving a sensing start signal generated by a wireless communication device installed near an entrance of the store triggers the sensor control unit to start collecting the sensing data.

12. The information processing device according to claim 6, further comprising a reward display unit that displays a reward given to the user when the personal information is disclosed to the store.

13. The information processing device according to claim 12, wherein
the reward is determined according to a reward return rate preset by the store depending on a type of the personal information.

14. The information processing device according to claim 12, wherein
the reward is given to the user when information about a movement of the user in the store is disclosed to the store even if the personal information does not include the movement path because the user does not make the payment.

15. The information processing device according to claim 6, wherein the information processing device is a server connected via a network to a mobile communication terminal carried by the user and further comprises a reward determination unit that determines a reward given to the user when the personal information is disclosed to the store.

16. An information processing method comprising computing, by a processor, starting from a payment position where a user entering a store pays, a movement path of the user in the store retrospectively according to time-series sensing data about the user obtained before the payment.

17. A program that allows a computer to function as a path computation unit that computes, starting from a payment position where a user entering a store pays, a movement path of the user in the store retrospectively according to time-series sensing data about the user obtained before the payment.
